(19) United States
(12) Patent Application Publication
(10) Pub. No.: US 2013/0114683 A1
(43) Pub. Date: May 9, 2013

(54) VIDEO DECODER WITH ENHANCED SAMPLE ADAPTIVE OFFSET

(71) Applicants: Jie ZHAO, Vancouver, WA (US); Christopher A. SEGALL, Camas, WA (US)

(72) Inventors: Jie ZHAO, Vancouver, WA (US); Christopher A. SEGALL, Camas, WA (US)

(73) Assignee: SHARP LABORATORIES OF AMERICA, INC., Camas, WA (US)

(21) Appl. No.: 13/290,388

(22) Filed: Nov. 7, 2011

(51) Int. Cl. H04N 7/26

(52) U.S. Cl. 375/240.03; 375/E07.139

(57) ABSTRACT

A decoder decodes video received in a bitstream containing quantized coefficients representative of blocks of video representative of a plurality of pixels and a plurality of offset type characteristics. Each of the plurality of offset type characteristics is associated with a respective block of the video. A deblocking process deblocks the video to reduce artifacts proximate boundaries between the blocks of the video. A sample adaptive offset process classifies a pixel based upon the offset type characteristic associated with the respective block of the video using a threshold criteria.

### CROSS-REFERENCE TO RELATED APPLICATIONS

None.

### BACKGROUND OF THE INVENTION

The present invention relates to image decoding with an enhanced sample adaptive offset.

Existing video coding standards, such as H.264/AVC, generally provide relatively high coding efficiency at the expense of increased computational complexity. As the computational complexity increases, the encoding and/or decoding speeds tend to decrease. Also, the desire for increased higher fidelity tends to increase over time which tends to require increasingly larger memory requirements and increasingly larger memory bandwidth requirements. The increasing memory requirements and the increasing memory bandwidth requirements tends to result in increasingly more expensive and computationally complex circuitry, especially in the case of embedded systems.

Referring to FIG. 1, many decoders (and encoders) receive (and encoders provide) encoded data for blocks of an image. Typically, the image is divided into blocks and each of the blocks is encoded in some manner, such as using a discrete cosine transform (DCT), and provided to the decoder. The decoder receives the encoded blocks and decodes each of the blocks in some manner, such as using an inverse discrete cosine transform.

Video coding standards, such as MPEG-4 part 10 (H.264) compress video data for transmission over a channel with limited frequency bandwidth and/or limited storage capacity. These video coding standards include multiple coding stages such as intra prediction, transform from spatial domain to frequency domain, quantization, entropy coding, motion estimation, and motion compensation, in order to more effectively encode and decode frames. Unfortunately, these coding techniques result in quantization errors, for example, the quantization errors at block boundaries become visible as ‘edging’ on blocks of video frames.

In order to compensate for these blocking effects, conventional coders and decoders may employ deblocking filters to smooth samples at the boundaries of each block. Traditional deblocking filters work on samples at the boundaries of block and do not compensate for errors within the blocks.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates an encoder and a decoder.

FIG. 2 illustrates an encoder.

FIG. 3 illustrates a decoder.

FIG. 4 illustrates another encoder.

FIG. 5 illustrates another decoder.

FIG. 6 illustrates yet another encoder.

FIG. 7 illustrates yet another decoder.

FIG. 8 illustrates a further encoder.

FIG. 9 illustrates a further decoder.

FIG. 10 illustrates yet a further encoder.

FIG. 11 illustrates yet a further decoder.

FIG. 12 illustrates a deblocking filter and a sample adaptive offset process.

FIG. 13 illustrates a horizontal deblocking process.

FIG. 14 illustrates a vertical deblocking process.

FIG. 15 illustrates different edge offset types

FIG. 16A illustrate sample adaptive offset classification process.

FIG. 16B illustrate a sample adaptive offset process.

FIG. 17 illustrates a sample edge offset sample adaptive offset.

FIG. 18 illustrates a more detailed deblocking filter and a sample adaptive offset process.

FIG. 19 illustrates a modified deblocking filter process and a modified sample adaptive offset process.

FIG. 20 illustrates a further modified deblocking filter process and a further modified sample adaptive offset process.

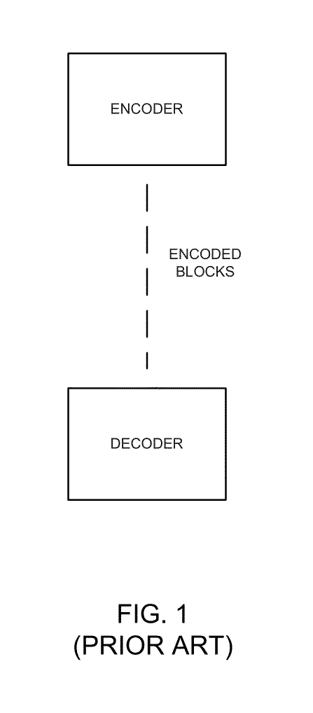

### DETAILED DESCRIPTION OF PREFERRED EMBODIMENT

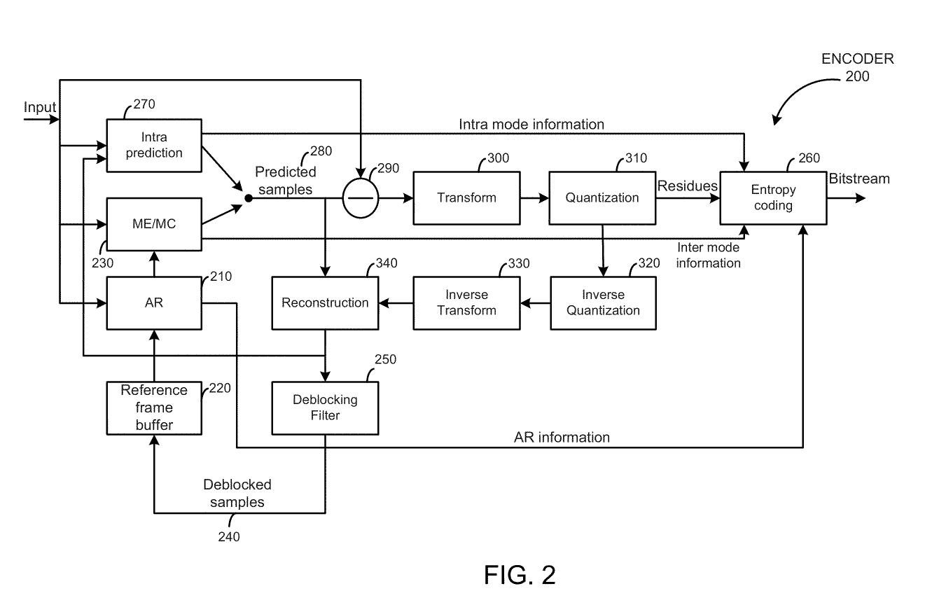

Referring to FIG. 2, an exemplary encoder 200 includes an adaptive restoration (AR) block 210, which may include a sample adaptive offset (SAO). The adaptive restoration (AR) block 210 may receive data from a reference frame buffer 220 and provide data to a motion estimation/motion compensation (ME/MC) block 230. Thus, deblocked samples 240 from a deblocking filter 250 are provided to the AR block 210 through a reference frame buffer 220 to perform restoration on one or more reference frames. Information from the AR block 210 is encoded and provided in the bitstream by the entropy coding block 260. The AR block 210 restores the reference frame stored in the reference frame buffer 220 in a manner which reduces a difference of matched blocks between the current frame and the reference frame.

As with many encoders, the encoder may further include an intra-prediction block 270 where predicted samples 280 are selected from the intra prediction block 270 and the ME/MC block 230. A subtractor 290 subtracts the predicted samples 280 from the input. The encoder 200 also may include a transform block 300, a quantization block 310, an inverse quantization block 320, an inverse transform block 330, a reconstruction block 340, and/or the deblocking filter 250. An adaptive loop filter may be included, if desired.

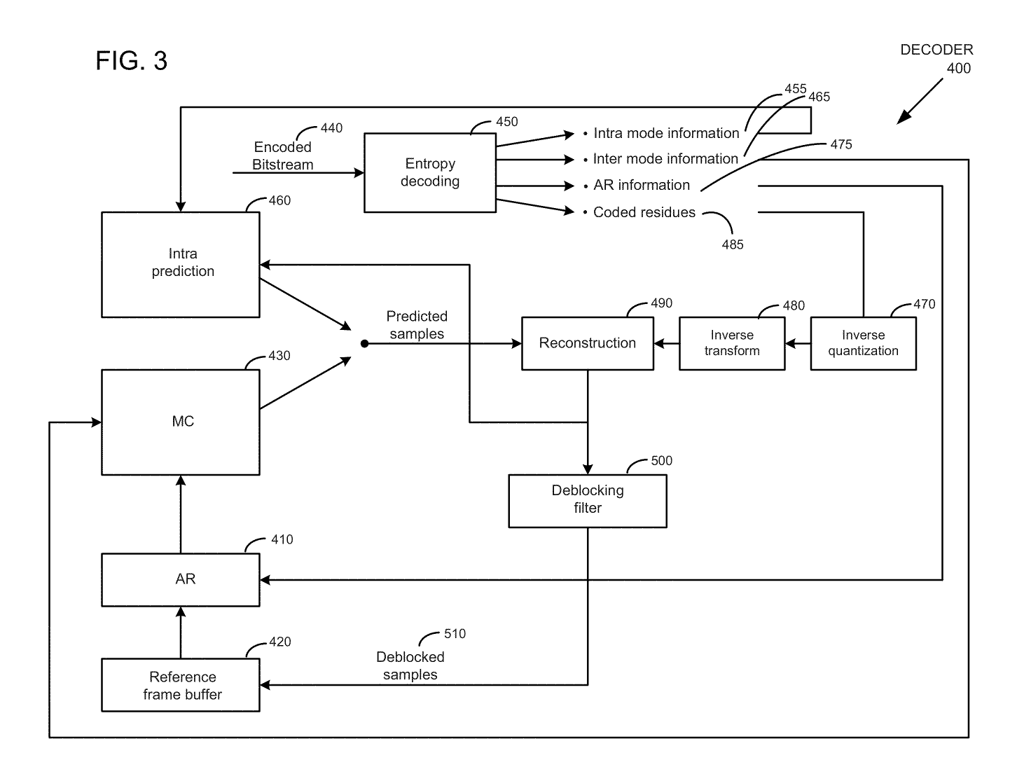

Referring to FIG. 3, an exemplary decoder 400 may include an AR block 410, which may include a sample adaptive offset (SAO), that receives data from a reference frame buffer 420 and provides data to a motion compensation (MC) block 430. The AR information that was embedded in the encoded bitstream 440 is retrieved by an entropy decoding block 450 in the decoder 400.

The entropy decoding block 450 may provide intra mode information 455 to an intra prediction block 460. The entropy decoding block 450 may provide inter mode information 465 to the MC block 430. The entropy decoding block 450 may provide the AR information 475 to the AR block 410. The entropy decoding block 450 may provide the coded residues 485 to an inverse quantization block 470, which provides data to an inverse transform block 480, which provides data to a reconstruction block 490, which provides data to the intra prediction block 460 and/or a deblocking filter 500. The deblocking filter 500 provides deblocked samples 510 to the reference frame buffer 420.

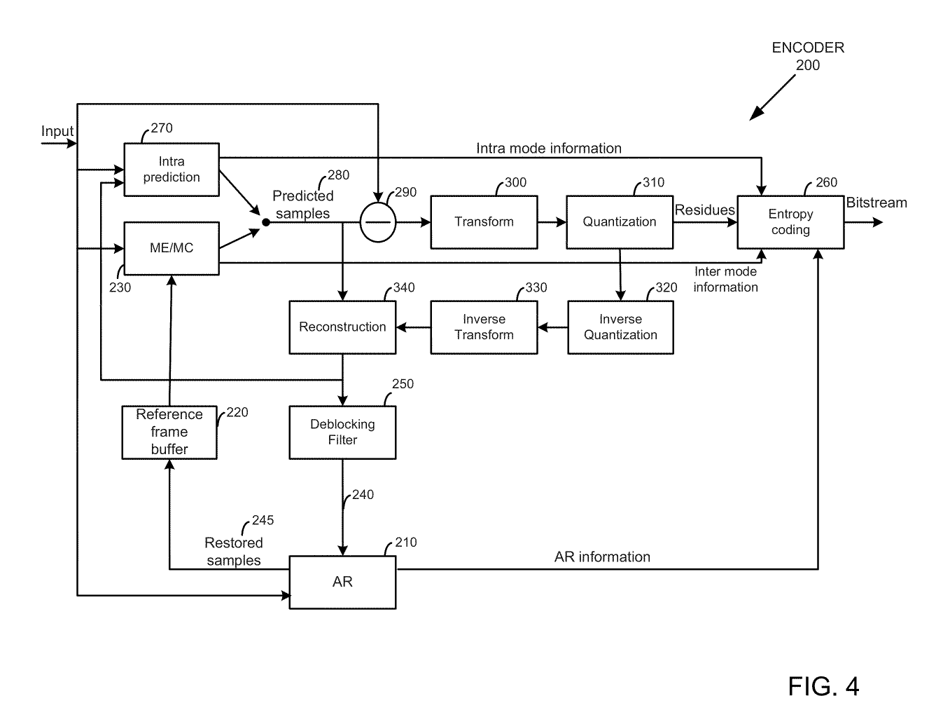

Referring to FIG. 4, another encoder includes a similar structure to FIG. 2, with the AR block 210 located after the deblocking filter 250 and before the reference frame buffer 220. More specifically the exemplary encoder 200 includes the adaptive restoration (AR) block 210. The adaptive restoration (AR) block 210 may provide restored samples 245 to the reference frame buffer 220 which provides data to the motion estimation/motion compensation (ME/MC) block 230. Thus, deblocked samples 240 from the deblocking filter 250 are provided to the AR block 210, which are provided to the reference frame buffer 220. Information from the AR block 210 is encoded and provided in the bitstream by the entropy coding block 260. The AR block 210 provides data which restores the reference frame stored in the reference frame buffer 220 in a manner which reduces a difference of matched blocks between the current frame and the reference frame. As with many encoders, the encoder may further include an intra-prediction block 270 where predicted samples 280 are selected between the intra prediction block 270 and the ME/MC block 230. A subtractor 290 subtracts the predicted samples 280 from the input. The encoder 200 also may include the transform block 300, the quantization block 310, the inverse quantization block 320, the inverse transform block 330, the reconstruction block 340, and/or the deblocking filter 250.

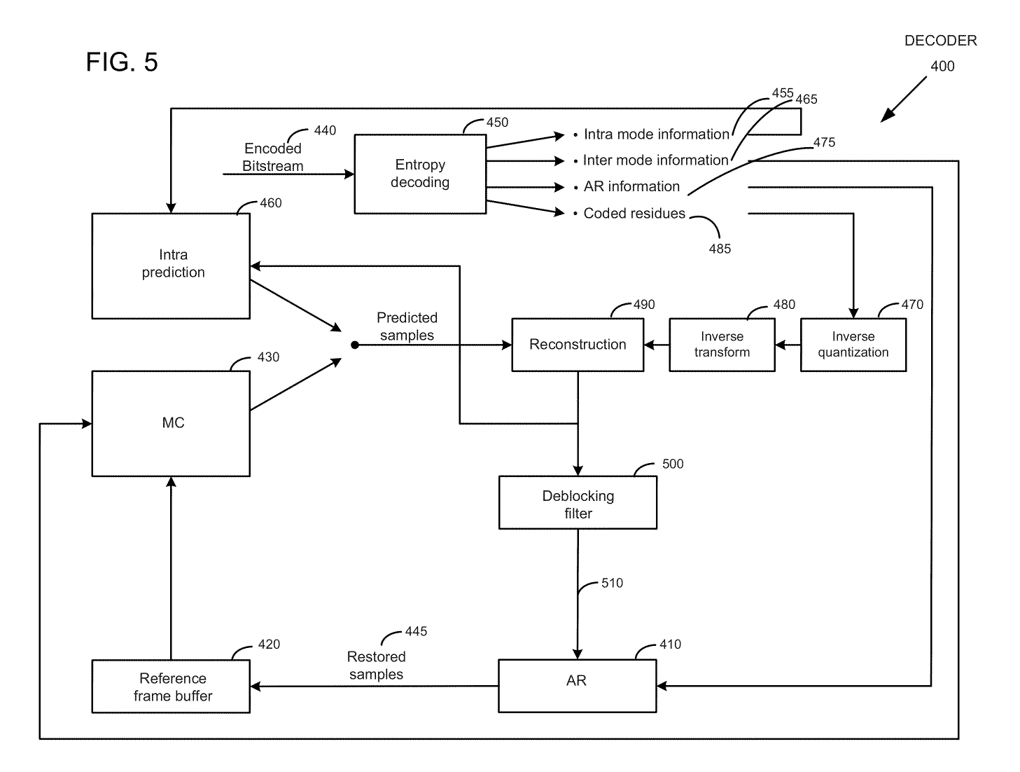

Referring to FIG. 5, an associated decoder for the encoder of FIG. 4 may include the AR block 410 in a corresponding location. More specifically, the exemplary decoder 400 may include the AR block 410 that provides restored samples 445 to the reference frame buffer 420 which provides data to the motion compensation (MC) block 430. The AR information that was embedded in the encoded bitstream 440 is retrieved by the entropy decoding block 450 in the decoder 400. The entropy decoding block 450 may provide the intra mode information 455 to the intra prediction block 460. The entropy decoding block 450 may provide the inter mode information 465 to the MC block 430. The entropy decoding block 450 may provide the AR information 475 to the AR block 410. The entropy decoding block 450 may provide the coded residues 485 to the inverse quantization block 470, which provides data to the inverse transform block 480, which provides data to the reconstruction block 490, which provides data to the intra prediction block 460 and/or the deblocking filter 500. The deblocking filter 500 provides deblocked samples 510 to the AR block 410.

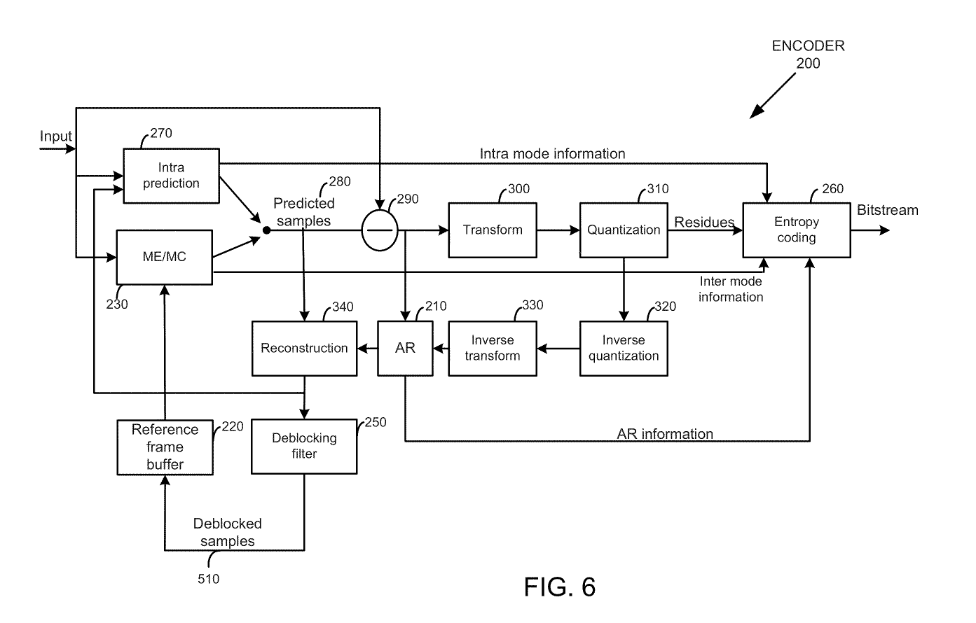

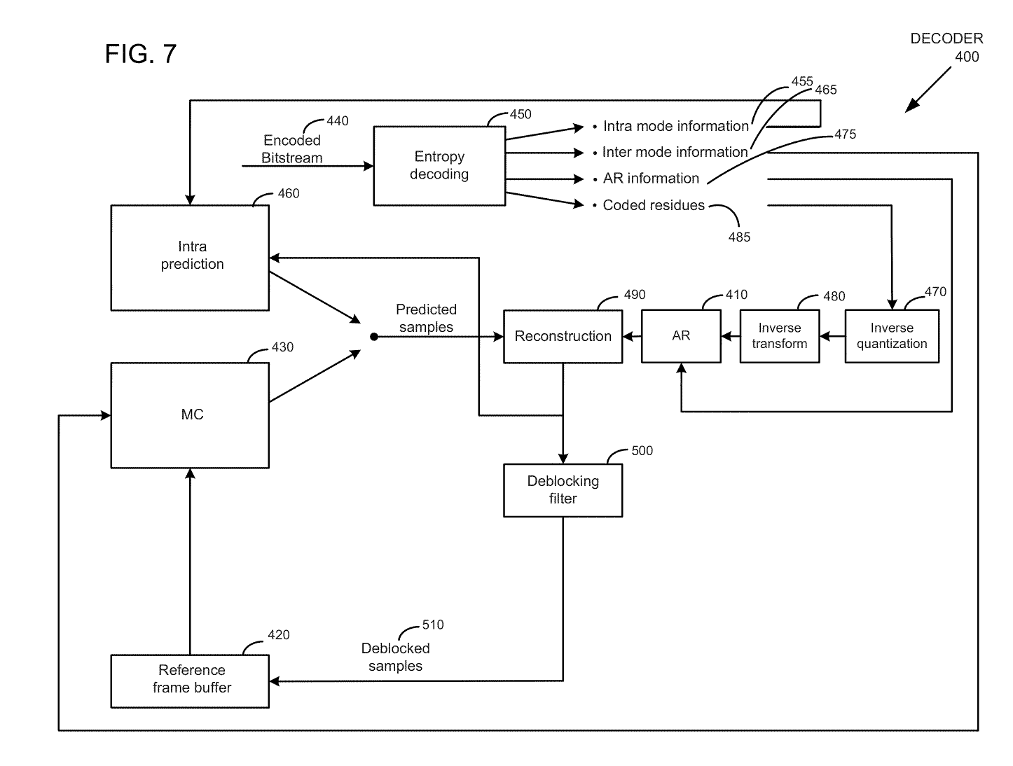

Referring to FIG. 6, another encoder 200 includes a similar structure to FIG. 2, with the AR block 210 located after the inverse transform block 330 and before the reconstruction block 340. Referring to FIG. 7, an associated decoder 400 of FIG. 6 may include the AR block 410 in a corresponding location.

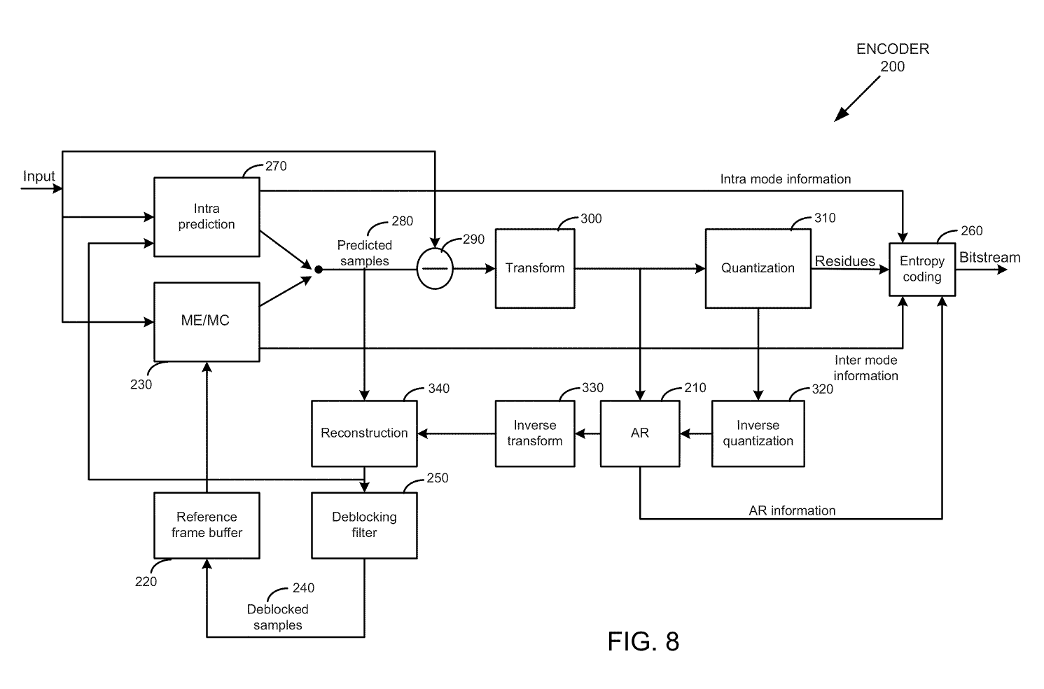

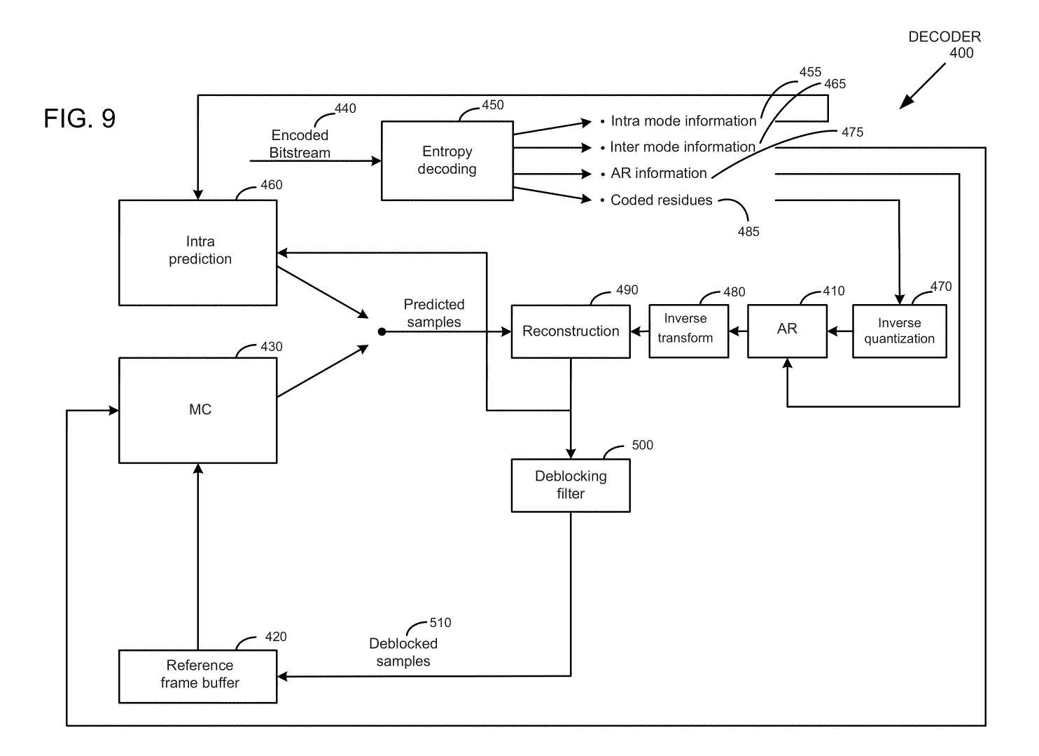

Referring to FIG. 8, another encoder 200 includes a similar structure to FIG. 2, with the AR block 210 located after the inverse quantization 320 and before the inverse transformation 330. Referring to FIG. 9, an associated decoder 400 of FIG. 8 may include the AR block 410 in a corresponding location.

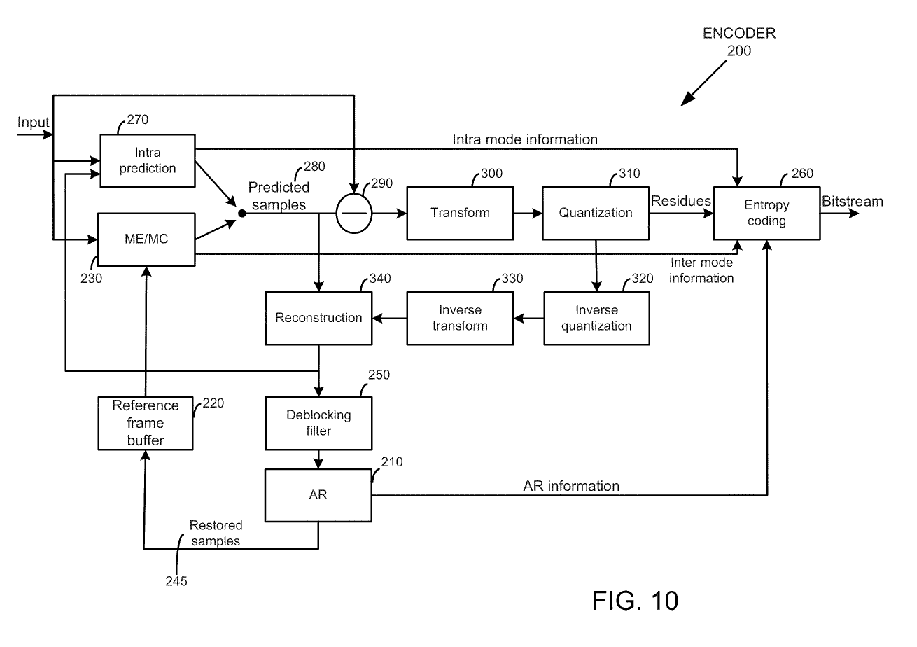

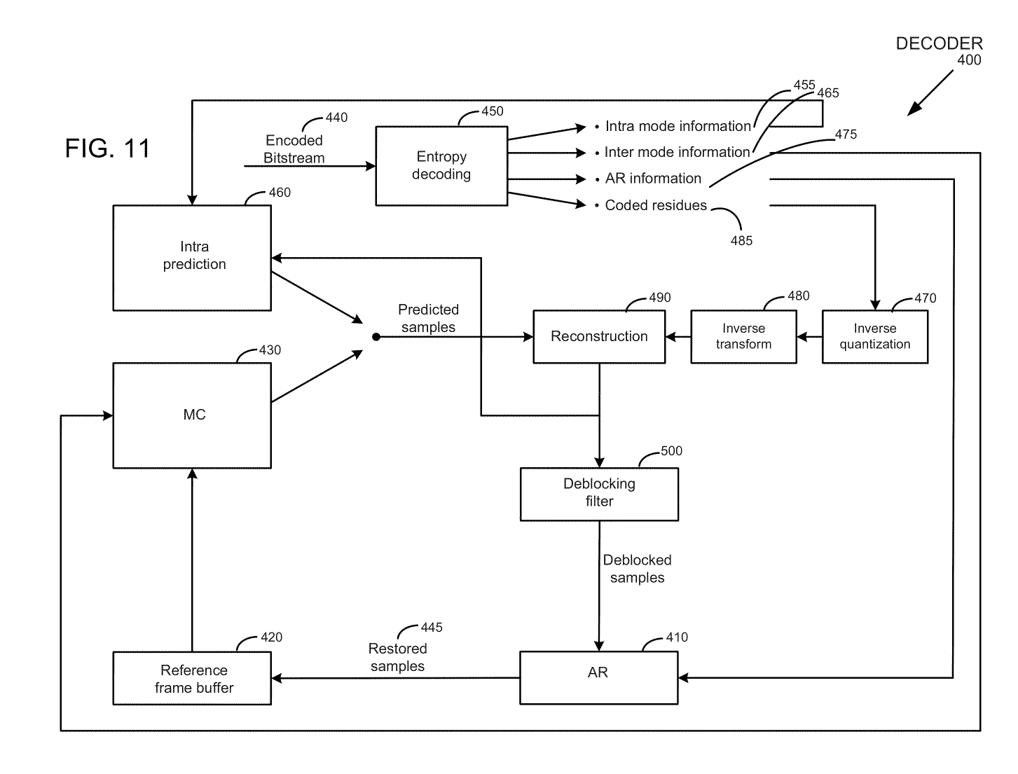

Referring to FIG. 10, another encoder 200 includes a similar structure to FIG. 2, with the AR 210 located after the deblocking filter 250 and before the reference frame buffer 220. Referring to FIG. 11, an associated decoder 400 of FIG. 10 may include the AR block 410 in a corresponding location.

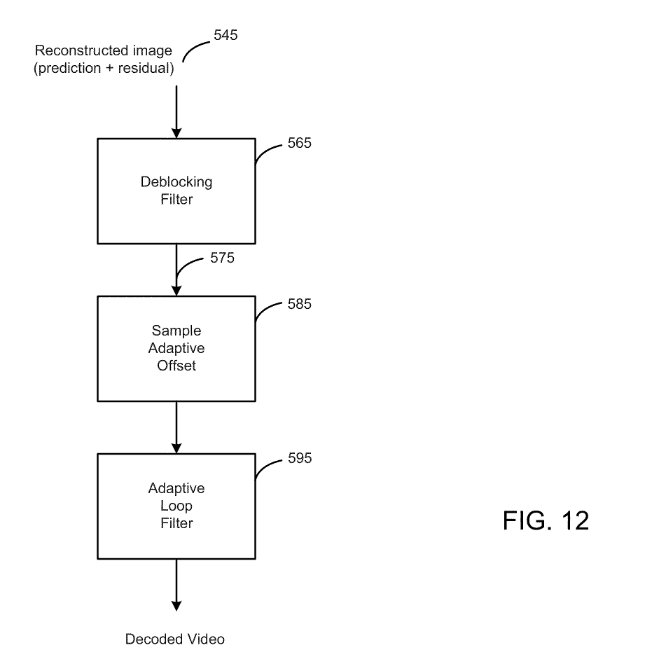

Referring to FIG. 12, in general the restoration filtering technique is applied to the reconstructed sample values to improve the performance for the encoding and/or decoding technique at both the encoder and the decoder. The deblocking filter 565 may receive the reconstructed image 545, which may include for example, a prediction and a residual. The deblocking filter 565 reduces the blocking artifacts along the coding block boundaries. The output of the deblocking filter 565 are deblocked sample values 575 and may be provided to an adaptive restoration filter, which in particular should provide a sample adaptive offset (SAO) 585 for the deblocked sample values 575. The sample adaptive offset 585 reduces the differences between the deblocked sample values 575 and the original sample values by adding offsets to the deblocked sample values 575. The output of the sample adaptive offset 585 may be provided to an optional adaptive loop filter 595. The adaptive loop filter 595 selects a set of filter coefficients to reduce the error, such as the mean square error, between the output of the sample adaptive offset 585 and the original image.

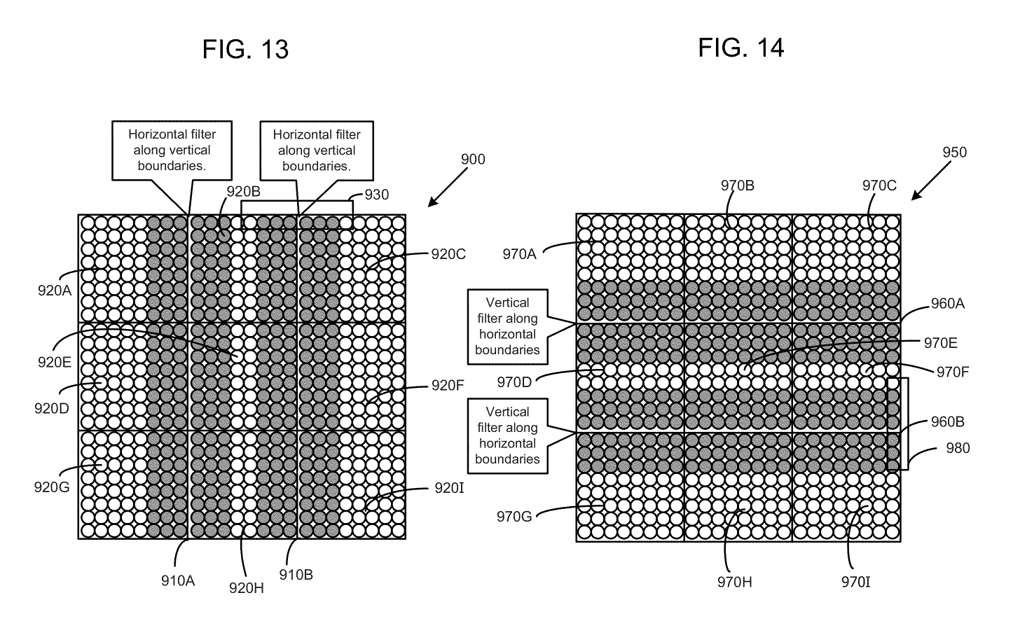

Referring to FIG. 13, the deblocking filter 500 may include a horizontal deblocking filter (illustrated graphically as 900 in FIG. 13) which may include the use of a 1-dimensional horizontal filter along the vertical boundaries 910A, 910B between blocks 920A-920I. By way of example, the deblocking filter may use an eight sample based filter 930 (illustrated graphically as a set of 8 samples) with four sample values on each side of the boundary 910A, 910B to make the deblocking decision. For example, up to three sample values (illustrated graphically as shaded sample values) on each side of the boundary 910A, 910B may be modified. The deblocking decisions are made using non-deblocked sample values and may be performed using parallel processing. Also, the deblocking decisions may be based upon partially deblocked data, such as the horizontal deblocking filter using partially deblocked data from the vertical deblocking filter.

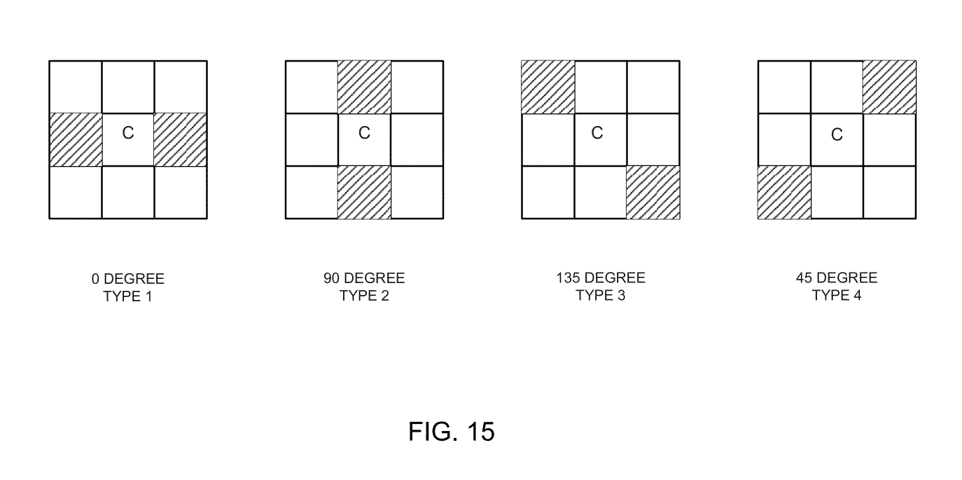

Referring to FIG. 14, the deblocking filter 500 may include a vertical deblocking filter (illustrated graphically as 950 in FIG. 14) which may include the use of a 1-dimensional vertical filter along the horizontal boundaries 960A, 960B between blocks 970A-970I. By way of example, the deblocking filter may use an eight sample based filter 980 (illustrated graphically as a set of 8 samples) with four sample values on each side of the boundary 960A, 960B to make the deblocking decision. For example, up to three sample values (illustrated graphically as shaded sample values) on each side of the boundary 960A, 960B may be modified. The deblocking decisions are made using reconstructed sample values and may be performed using parallel processing. Also, the deblocking decisions may be based upon partially deblocked data, such as the vertical deblocking filter using partially deblocked data from the horizontal deblocking filter.

Referring also to Table 1, the sample adaptive offset 520 may include adding (e.g., adding a positive number and/or adding a negative number) offsets to the deblocked sample values so that they are closer to the original sample values. In some encoding and decoding systems, the picture is divided into multiple blocks (e.g, coding units) by recursive quad-tree split. An SAO split flag indicates whether a region is further split or not, and can be used to derive the block locations. Each of the blocks may be assigned one of a plurality of sample adaptive offset types, such as 7 offset types, based upon the characteristics of the samples in the block. For example, the sample adaptive offset type 1 may be a 1-dimensional 0-degree pattern edge offset. For example, the sample adaptive offset type 2 may be a 1-dimensional 90-degree pattern edge offset. For example, the sample adaptive offset type 3 may be a 1-dimensional 135-degree pattern edge offset. For example, the sample adaptive offset type 4 may be a 1-dimensional 45-degree pattern edge offset. For example, the sample adaptive offset type 5 may be a central bands band offset. For example, the sample adaptive offset type 6 may be a side bands band offset. For example, the sample adaptive offset type 0 means no SAO processing. This selection of the particular offset type is performed by the encoder, and the selected offset type is provided to and received by the decoder. For example, the sample adaptive offset types may be signaled in the bitstream.

TABLE 1

| | | NUMBER OF |
|---|---|---|
| TYPE | DESCRIPTION OF SAO TYPE | CATEGORIES |
| 0 | None | 0 |
| 1 | 1-D 0 degree pattern edge offset | 4 |
| 2 | 1-D 90 degree pattern edge offset | 4 |
| 3 | 1-D 135 degree pattern edge offset | 4 |
| 4 | 1-D 45 degree pattern edge offset | 4 |
| 5 | Central bands Band Offset | 16 |
| 6 | Side Bands Band Offset | 16 |

For example, the band offset type classifies all sample locations of a block into multiple bands (generally also referred to as categories), where the bands contain sample values being similar and have derived offsets. The middle 16 bands are referred to as the center bands band offset which occur in the case of offset type 5. The rest of the 16 bands are referred to as the side bands which occur in the case of offset type 6. The offset for each of the categories are sent in the bitstream. For example, the four edge offset types may include, a 0 degree edge offset, a 45 degree edge offset, a 90 degree edge offset, and a 135 degree edge offset. An additional SAO type 0 may indicate no processing.

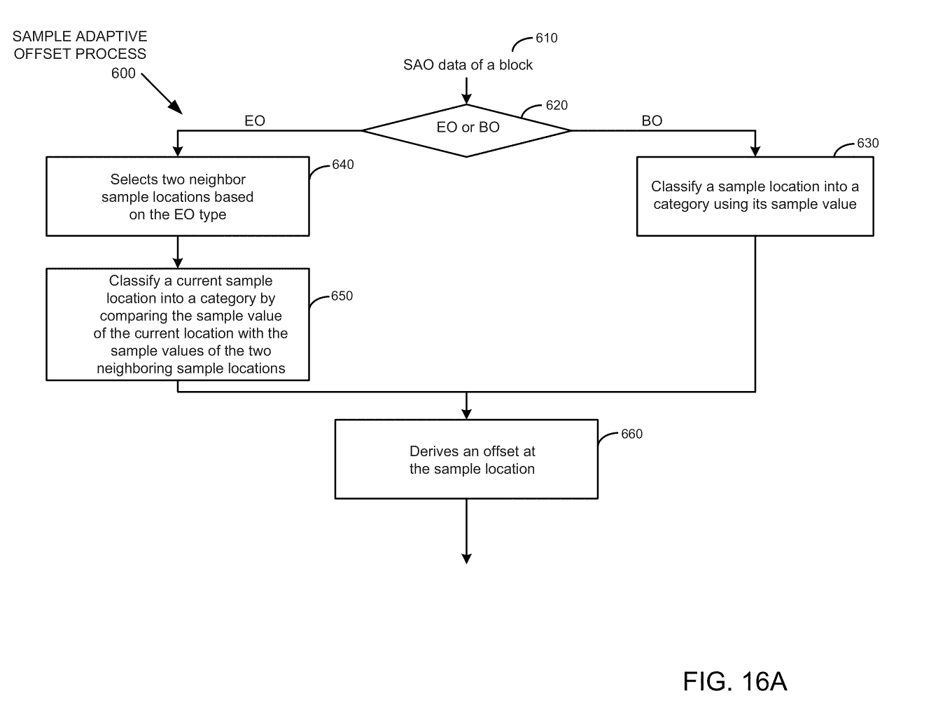

Within a region of an edge offset type, each sample location is further classified into categories by comparing with neighbor sample locations. Referring to FIG. 15, depending on the edge offset type two neighbor sample locations are selected. For each of the sample of a group of samples and for each of the sample adaptive offset types, may be further classified into different categories based upon sample characteristics. This categorization may be performed at both the encoder and the decoder in a same way. For example, offset types 1, 2, 3, and 4 may have 4 different categories, while offset types 5 and 6 may have 16 different categories. Typically, the categories for each of the sample adaptive offset types are computed by the encoder and the decoder, but not expressly signaled in the bitstream. However, the categories may be signaled in the bitstream, if desired. Accordingly, an offset is derived for each sample location for each category of each block having a sample adaptive offset type and is added to a deblocked sample value to generate the resulting output sample value of the sample adaptive offset.

As noted, within a block defined as an edge offset type or band offset type, each sample location may be further classified into categories. For example, each of the band offset types may include 16 different categories. For example, each of the edge offsets may include 4 different categories, and an additional category 0 which is for no processing. One technique to determine which category is suitable particular edge offset is based upon the following conditions:

| Category | Condition |
|---|---|
| Category 1 | c < both neighboring pixels; |
| Category 2 | c < 1 neighboring pixel and c = 1 neighboring pixel; |
| Category 3 | c > 1 neighboring pixel and c = 1 neighboring pixel; |
| Category 4 | c > both neighboring pixels; |
| Category 0 | c is between neighbor pixels or c = |
| (None of the above) | both neighboring pixels. |

Here, c is the sample value at a sample location to be categorized, neighboring pixel is the sample value at a sample location signaled by the edge offset type, and neighboring pixels are the sample values at more than one sample location identified by the edge offset type, as shown by FIG. 15. As it may be observed, the categories for the bands offset type are based only upon the sample value itself, and categories for the edge offset type are based upon sample values at neighboring sample locations.

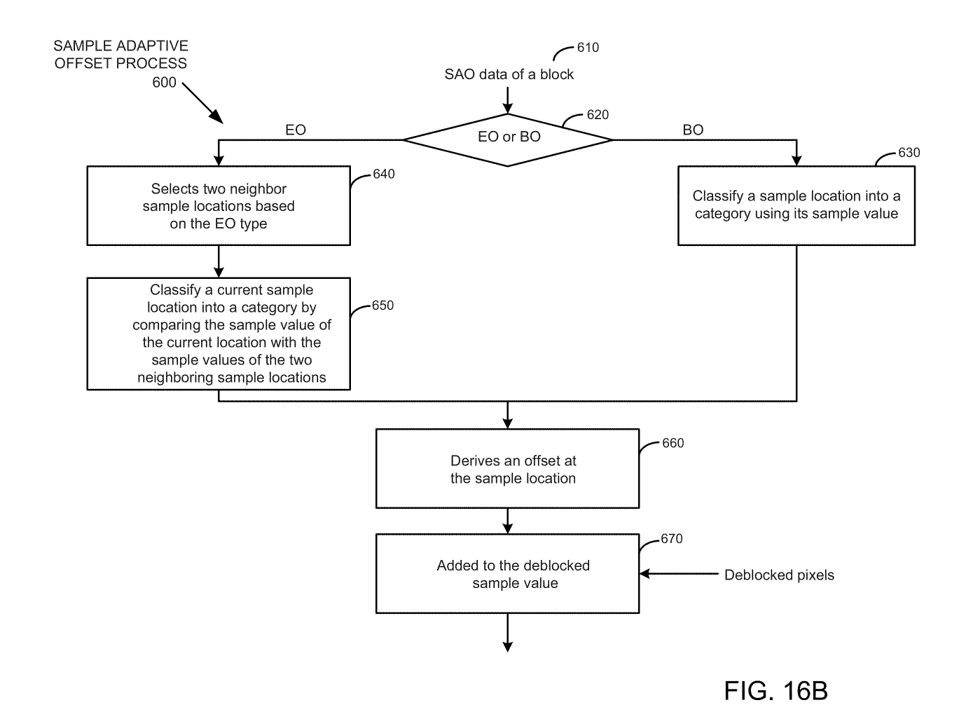

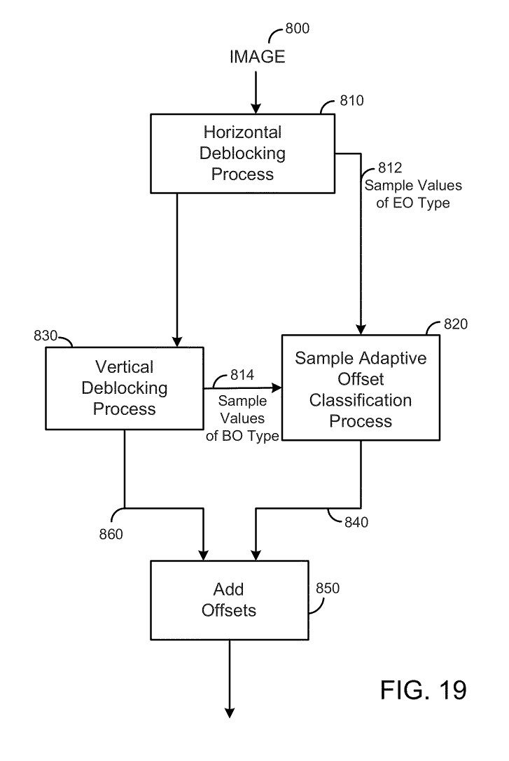

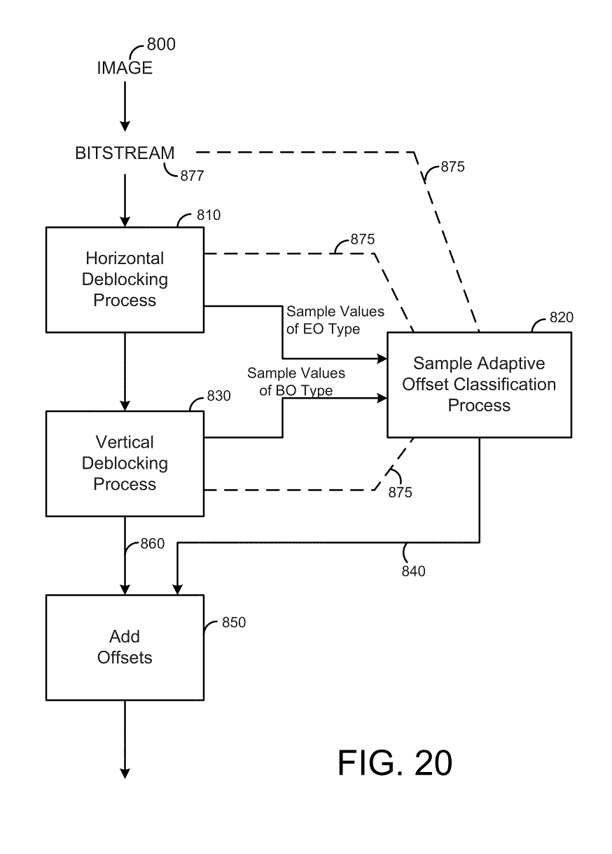

Referring to FIG. 16A, an exemplary sample adaptive offset classification process 600 is illustrated. This process is invoked when SAO type is not 0. Sample adaptive offset data of a block 610 is received for an image. The sample adaptive offset process 600 makes a decision at block 620 to determine whether the sample adaptive offset type is an edge offset type (EO) or band offset type (BO). For band offset type, the sample adaptive offset process 600 classifies a sample location into a category using its sample value 630. For edge offset, the sample adaptive offset process 600 selects two neighbor sample locations based on the edge offset type 640. After selecting the two neighbor sample locations, the sample adaptive offset process 600 classifies a current sample location into a category by comparing the sample value of the current location with the sample values of the two neighboring sample locations 650. Accordingly, the process from receiving the SAO data of a block 610 until the process derives an offset at the sample location 660 results performs an SAO classification process (see sample adaptive offset classification process 820 of FIG. 19 and FIG. 20). Referring to FIG. 16B, based upon the category determined, the sample adaptive offset process 600 derives an offset at the sample location 660. The offset derived at the sample location 660 is added to the deblocked sample value 670 to provide a sample adaptive offset output 680.

Providing a deblocking filter process and a separate sample adaptive offset process typically requires a separate pass through the data with associated memory storage requirements and computational complexity. The computational complexity, latency, and memory storage requirements may be reduced if the deblocking filter process and the sample adaptive offset process were combined in a manner that alleviated the need for separate passes through the data. Moreover, the combining of the deblocking filter process and the sample adaptive offset process may further enable more effective parallel processing of image data. Unfortunately, the edge offset type sample adaptive offset process uses neighboring deblocked sample values which may not have yet been deblocked when it is desirable to determine the sample adaptive offset for the sample location of interest. Accordingly, merely using a deblocking filter process for a sample value and immediately thereafter determining a sample adaptive offset for the sample value, on a sample by sample basis, is not a suitable technique due to the spatial aspects of the edge offset type sample adaptive offset. Moreover, this spatial characteristic of the edge offset type complicates parallel processing based techniques.

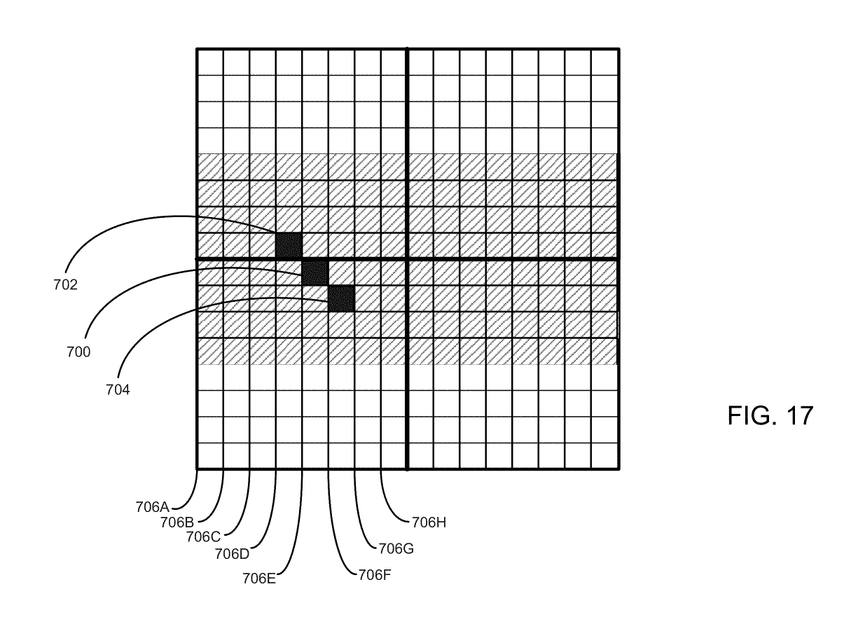

Referring to FIG. 17, by way of example, if a block has an edge offset type of 135 degrees the sample adaptive offset processes a sample value 700 of that block together with two other sample values 702 and 704 to determine the offset. In the event that the columns 706A-706H are sequentially processed, then when sample value 700 is just deblocked, both neighboring sample values may not have been deblocked yet. Therefore, the sample adaptive offset process is not suitable for immediate classification after a sample value is deblocked, if the block has an edge offset type. In contrast, for a block of band offset type, since the sample adaptive offset classification only requires the current sample value and it does not have a similar dependency limitation. In other words, deblocked neighbor sample values 702 and 704 are used for SAO classification of the sample 700 to determine the SAO offset. Since neighboring sample values 702 and 704 may not have been deblocked yet, therefore the SAO classification of the sample 700 may not have been done immediately after the sample 700 is deblocked, and thus has to wait until the neighbor samples 702 and 704 are also deblocked. This waiting results in a temporal dependency of SAO on future deblocked neighbor's samples. Therefore, for an SAO region of EO type, it is unable to add SAO offset immediately after a pixel is deblocked. This also makes it difficult to combine SAO into parallel deblocking process.

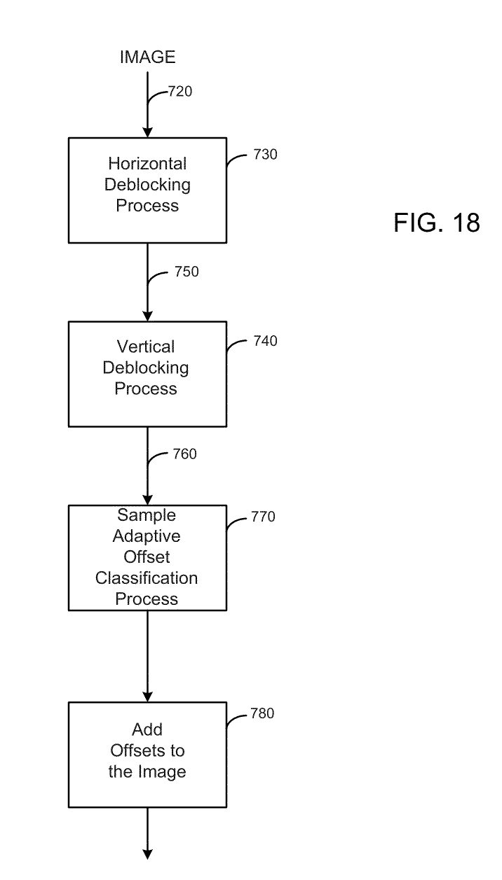

Referring to FIG. 18, to process an image 720 a horizontal deblocking process 730 may be performed for the image 720, then when the horizontal deblocking process 730 is completed a vertical deblocking process 740 may be performed for the image 750 from the horizontal deblocking process 730. After the image is deblocked using the horizontal deblocking process 730 and the vertical deblocking process 740, the resulting image 760 is processed by a sample adaptive offset classification process 770. Based upon the sample adaptive offset classification process 770 a set of offsets are added to the image 780. For example, the image may be all or part of a frame or a set of sample values.

To reduce the temporal dependency of the sample adaptive offset process from the deblocked sample values, together with reducing the latency of the sample adaptive offset process after deblocking, it is desirable to modify the process. Referring to FIG. 19, a modified technique involves processing an image 800 using a horizontal deblocking process 810. After the horizontal deblocking process 810, the sample values are at least partially processed in a manner that reduces the deblocking artifacts that would otherwise be present in the image 800. Also, after the horizontal deblocking process 810 sample values of those sample locations that are of the edge offset type 812 may be used to perform a sample adaptive offset classification process 820. The sample values from the horizontal deblocking process 810 are stored in memory for a subsequent vertical deblocking process 830, and accordingly the same sample values may be used as the basis for the edge offset type classifications. The remaining temporal dependency of the sample adaptive offset classification process 820 resulting during the vertical deblocking process 830 does not result in problems because the sample values are sufficiently deblocked when the sample values are obtained from the horizontal deblocking process 810 for the edge offset type 812. In some cases, the edge offset type based sample adaptive offset classification process 820 may be based upon sample values after a sufficient portion of the frame is horizontally deblocked by the horizontal deblocking process 810 such that the temporal dependency is no longer present (e.g., the selected neighboring sample values shown in FIG. 15 are already horizontally deblocked). In other words, the edge offset type 812 sample values used for the sample adaptive offset classification process 820 do not simultaneously use sample values that are vertically deblocked and horizontally deblocked for classification.

The sample values from the horizontal deblocking process 810 are provided to the vertical deblocking process 830. After the vertical deblocking process 830, or as sample values of the vertical deblocking process 830 are deblocked, those sample values of sample locations that are of the band offset type 814 may be used for the sample adaptive offset classification process 820. The band offset type 814 does not have the temporal characteristics of the edge offset type 812, and accordingly such sample values may be made available to the sample adaptive offset classification process 820 as it becomes available, without the need to first store an entire vertically deblocked image.

As illustrated, the sample adaptive offset classification process 820 may be based upon two different sources of data, as defined by the offset type. In some embodiments, the horizontal and vertical deblocking processes may be reversed. In some embodiments, the edge offset type and/or band offset type classifications may be based upon non-deblocked data.

After the sample adaptive offset classification process 820 determines a category for a sample location based upon its offset type, an offset 840 may be determined which is then added 850 to the horizontally and vertically deblocked sample values 860. Accordingly, the system preferably adds the offset to the fully deblocked sample values.

Referring to FIG. 20, in another embodiment of the invention the horizontal deblocking process 810 and/or vertical deblocking process 830 often characterize the offset type of filtering to be applied to the sample locations. Also, the bitstream 877 may signal the offset type of filtering to be applied to filters within the horizontal and vertical deblocking processes 810, 830. For example, the horizontal and vertical deblocking processes 810, 830, may determine deblocking information that should be applied to filters within the horizontal and vertical deblocking processes 810, 830 such as on, off, strong, weak, or any other characteristic of the nature of the filtering to be applied to the sample locations. Other bitstream information may further include block information, such as for example, intra-prediction, inter-prediction, bi-directional prediction, forward prediction, and backward prediction. The deblocking information 875 may be provided from the bitstream 877, the horizontal deblocking process 810, and/or the vertical deblocking process 830 to the sample adaptive offset classification process 820. The sample adaptive offset classification process 820 may be modified based upon the deblocking information. In this manner, the classification technique may be improved.

In a further embodiment of the invention, having sample values sufficiently close in value to one another indicates that they should be considered as being the same for classification purposes. The sufficiently close criteria may be a static or variable threshold. For example, the threshold should be no more the difference between the two neighboring pixels. The threshold may be based upon any suitable criteria, such as for example, the deblocking information and/or the sample adaptive offset. One technique to determine which category is suitable for a particular edge offset is based upon the following conditions incorporating a threshold (TH):

| Category | Condition |
|---|---|
| Category 1 | c < both neighboring pixels − TH |
| Category 2 | c < 1^{st} neighboring pixel − TH and |
| | c > 2^{nd} neighboring pixel − TH and |
| | c < 2^{nd} neighboring pixel + TH |
| Category 3 | c > 1^{st} neighboring pixel + TH and |
| | c > 2^{nd} neighboring pixel − TH and |
| | c < 2^{nd} neighboring pixel + TH |
| Category 4 | c > both neighboring pixels + TH |
| Category 0 (none of above) | c > Min(both neighboring pixels) + TH and |
| | c < Max(both neighboring pixels) − TH; |
| | or c = both neighbor pixels |

Here, 1^{st} neighboring pixel is the sample value at a first sample location signaled by the edge offset type, 2^{nd} neighboring pixel is the sample value at a second sample location signaled by the edge offset type, TH is a threshold and ‘and’ denotes the logical and operation. In another example, the 1^{st} neighboring pixel is the sample value at a second sample location signaled by the edge offset type, the 2^{nd} neighboring pixel is the sample value at a first sample location signaled by the edge offset type, TH is a threshold and ‘and’ denotes the logical and operation.

The aforementioned relationships may also be defined in terms of greater than or equal or, or less than or equal to. Moreover, the relationship of greater than or equal to, or less than or equal to, may be accomplished my modification of the threshold value.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A decoder that decodes video comprising:
(a) said decoder receives a bitstream containing quantized coefficients representative of blocks of video representative of a plurality of pixels and a plurality of offset type characteristics, each of said plurality of offset type characteristics is associated with a respective block of said video;
(b) a deblocking process that deblocks said video to reduce artifacts proximate boundaries between said blocks of said video;
(c) a sample adaptive offset process that classifies a pixel based upon said offset type characteristic associated with said respective block of said video using a threshold criteria.

2. The decoder of claim 1 wherein said threshold criteria is a static threshold.

3. The decoder of claim 1 wherein said threshold criteria is a dynamic threshold.

4. The decoder of claim 1 wherein said threshold criteria is based upon at least one of deblocking information, said offset type characteristic, block offset type, and prediction information.

5. The decoder of claim 1 wherein said offset type characteristic is an edge offset and said classification is based upon a threshold into one of at least three of the following categories:

| | |
|---|---|
| category 1 | c < both neighboring pixels − TH; |
| category 2 | c < 1^{st} neighboring pixel − TH and, |
| | c > 2^{nd} neighboring pixel − TH and |
| | c < 2^{nd} neighboring pixel + TH; |
| category 3 | c > 1^{st} neighboring pixel + TH and, |
| | c > 2^{nd} neighboring pixel − TH and |
| | c < 2^{nd} neighboring pixel + TH; |
| category 4 | c > both neighboring pixels + TH; |
| category 0 | c > Min(neighboring pixels) + TH |
| (none of the above) | and c < Max(neighboring pixels) − TH; or |
| | c = both neighbors |
